(19) United States
(12) Patent Application Publication
(10) Pub. No.: US 2017/0040864 A1
(43) Pub. Date: Feb. 9, 2017

(54) Electric Compressor

(71) Applicant: SANDEN HOLDINGS CORPORATION, Isesaki-shi (JP)

(72) Inventor: Tetsuya TAKABE, Isesaki-shi (JP)

(21) Appl. No.: 15/305,381

(22) PCT Filed: Mar. 16, 2015
(86) PCT No.: PCT/JP2015/057721

§ 371 Date: Oct. 20, 2016

(30) Foreign Application Priority Data
Apr. 22, 2014 (JP) 2014-088509

(51) Int. Cl. H02K 5/24; F04C 29/00; H02K 1/18; F04C 18/02

(52) U.S. Cl. CPC H02K 5/24; F04C 18/0215; F04C 29/0085; H02K 1/18; F04C 2240/30; F04C 2240/40

(57) ABSTRACT

Electric compressor 1 including: an electric motor 10 which includes a rotor 2 that has six or eight magnetic poles, and a stator 3 that is disposed radially outside the rotor 2 and that has nine or twelve slots opening toward the rotor 2; a compression mechanism 20 driven by the electric motor 10 to compress refrigerant; and a casing 40 which houses the electric motor 10 and the compression mechanism 20, the electric compressor further includes four or three protrusions 41f formed protruding from either an inner periphery of the casing 40 or an outer periphery of the stator 3 so as to be spaced apart from each other in a circumferential direction, and the stator 3 is fixed to the casing 40 by way of the protrusions 41f.

### TECHNICAL FIELD

The present invention relates to an electric compressor which is used for compressing refrigerant in a vehicle air conditioner or the like, and which integrally includes a compression mechanism and an electric motor for driving the compression mechanism.

### BACKGROUND ART

Such an electric compressor is disclosed, for example, in Patent Document 1. In the electric compressor disclosed in Patent Document 1, an electric motor and a compression mechanism are housed in a casing. The electric motor includes a rotor that has multiple magnetic poles, and an annular stator that is disposed radially outside the rotor and that has multiple slots. The compression mechanism is driven by the electric motor. The stator is inserted and fitted into a body casing, and fixed to the body casing by swaging, specifically, putting a pressure on a contact interface between the body casing and the stator toward an end surface thereof. The casing is separated into the body casing for housing the electric motor and a sub-casing for housing the compression mechanism. The body casing has a tubular shape with a bottom, and the sub-casing covers the open end of the body casing. In the open end of the sub-casing, multiple through holes are formed for allowing fastening bolts to be inserted so that the sub-casing can be fastened to the body casing. The through holes are spaced apart from each other in the circumferential direction. In the open end of the body casing, multiple screw holes are formed for the fastening bolts so as to face the through holes. In each of these casings, fastening portions in which the through holes or the screw holes are formed are thicker than the other portions in which no through or screw hole is formed. On the outer periphery (the circumferential surface) of the casing, a fixing portion for fixing the electric compressor to an installation target (such as a vehicle) is protrudingly formed.

In such an electric compressor, as a common practice, multiple protrusions are formed on the outer periphery of the stator so as to be spaced apart from each other in the circumferential direction, and the stator is fixed to the casing by shrink fitting the protrusions to the casing.

### REFERENCE DOCUMENT LIST

### Patent Document

Patent Document 1: JP 2011-196212 A

### SUMMARY OF THE INVENTION

### Problems to be Solved by the Invention

In such an electric compressor including a so-called inner-rotor electric motor in which a rotor having multiple magnetic poles is disposed radially inside a stator having multiple slots, the following is observed. When an electric current having an appropriate phase is supplied to coils wound around teeth between the slots, an electromagnetic force is applied to parts including the teeth. As a result, while the electromagnetic force is applied, these parts including the teeth are slightly deformed and vibrated in the radial direction in synchronization with the changes in the phase and the like of the electric current inputted to the coils that are wound around the teeth. The vibration generated in the stator (including the teeth) is transmitted to the casing through the swaged portions and the shrink-fitted portions, and then further transmitted to the installation target (such as a vehicle) through the fixing portion formed on the outer periphery of the casing. Therefore, there has been a demand for an approach that reduces vibration transmission to the installation target.

In such an electric compressor, a 6-pole (magnetic poles) 9-slot electric motor or an 8-pole 12-slot electric motor is typically employed.

The present inventor has confirmed by analysis that, in a 6-pole (magnetic poles) 9-slot electric motor, while an electromagnetic force is applied to the stator, the stator is deformed to have a quasi-equilateral triangle outer shape, and its three corner portions move around the rotation axis of the rotor in synchronization with each other in accordance with the phase and the like of the electric current (in other words, the stator vibrates as if its deformed shape of quasi-equilateral triangle rotates). Similarly, the present inventor has also confirmed by analysis that, in an 8-pole (magnetic poles) 12-slot electric motor, the stator is deformed to have a quasi-square outer shape, and its four corner portions move around the rotation axis of the rotor in synchronization with each other.

As described above, in such an electric compressor, the stator is deformed into a specific shape corresponding to the number of its magnetic poles and the number of its slots, and this deformed shape might increase the adverse effects of vibration transmission.

The present invention has been made in view of such circumstances, and an object thereof is to provide an electric compressor capable of appropriately suppressing vibration transmission in consideration of a specific deformed shape of a stator corresponding to the number of its magnetic poles and the number of its slots.

### Means for Solving the Problems

According to an aspect of the present invention, in an electric compressor including: an electric motor which includes a rotor that has six magnetic poles, and a stator that is disposed radially outside the rotor and that has nine slots opening toward the rotor; a compression mechanism driven by the electric motor to compress refrigerant; and a casing which houses the electric motor and the compression mechanism, the electric compressor further includes four protrusions formed protruding from either an inner periphery of the casing or an outer periphery of the stator so as to be spaced apart from each other in a circumferential direction, and the stator is fixed to the casing by way of the protrusions.

According to another aspect of the present invention, in an electric compressor including: an electric motor which includes a rotor that has eight magnetic poles, and a stator that is disposed radially outside the rotor and that has twelve slots opening toward the rotor; a compression mechanism driven by the electric motor to compress refrigerant; and a casing which houses the electric motor and the compression mechanism, the electric compressor further includes three protrusions formed protruding from either an inner periphery of the casing or an outer periphery of the stator so as to be spaced apart from each other in a circumferential direction, and the stator is fixed to the casing by way of the protrusions.

### Effects of the Invention

The electric compressor according to the former aspect includes the 6-pole 9-slot electric motor, and the stator is fixed to the casing by way of the four protrusions that are formed protruding from either the inner periphery of the casing or the outer periphery of the stator so as to be spaced apart from each other in the circumferential direction. Thus, the stator may be fixed to the casing by shrink fitting the four protrusions to the stator, for example. Therefore, even while the stator is deformed into a quasi-equilateral triangle and its three corner portions move around the rotation axis of the rotor in synchronization with each other in accordance with the phase and the like of the electric current, the electric compressor permits only one of the three corner portions to overlap any one of the four protrusions at each moment.

This prevents the positions of two or three of the three corner portions from simultaneously overlapping any of the positions of the protrusions at each moment. Thus, the electric compressor according to the former aspect can more appropriately suppress vibration transmission than an electric compressor that permits such a simultaneous overlap.

The electric compressor according to the latter aspect includes the 8-pole 12-slot electric motor, and the stator is fixed to the casing by way of the three protrusions that are formed protruding from either the inner periphery of the casing or the outer periphery of the stator so as to be spaced apart from each other in the circumferential direction. Thus, the stator may be fixed to the casing by shrink fitting the three protrusions to the stator, for example. Therefore, even while the stator is deformed into a quasi-square and its four corner portions move around the rotation axis of the rotor in synchronization with each other in accordance with the phase and the like of the electric current, the electric compressor permits only one of the four corner portions to overlap any one of the three protrusions at each moment.

This prevents the positions of two to four of the four corner portions from simultaneously overlapping any of the positions of the protrusions at each moment. Thus, the electric compressor according to the latter aspect can more appropriately suppress vibration transmission than an electric compressor that permits such a simultaneous overlap.

In this way, there can be provided an electric compressor capable of appropriately suppressing vibration transmission in consideration of a specific deformed shape of a stator corresponding to the number of its magnetic poles and the number of its slots.

### BRIEF DESCRIPTION OF THE DRAWINGS

FIG. 1 is a cross-sectional view of an electric compressor according to a first embodiment of the present invention.

FIG. 2 is a front view of a first casing as viewed in the direction indicated by arrow A-A of FIG. 1.

FIG. 3 is an enlarged view of area X of FIG. 2

FIG. 4 is a perspective view of an assembled stator unit of the electric compressor according to the embodiment.

FIG. 5 is an exploded perspective view of the stator unit shown in FIG. 4.

FIG. 6 is a conceptual diagram illustrating a deformed shape of the stator having nine slots according to the embodiment.

FIG. 7 shows frequency response characteristics of an upper fixing portion while the electric motor according to the embodiment vibrates.

FIG. 8 shows frequency response characteristics of a lower fixing portion while the electric motor according to the embodiment vibrates.

FIG. 9 is a conceptual diagram illustrating a deformed shape of a stator having twelve slots in an electric compressor according to a second embodiment of the present invention.

### MODE FOR CARRYING OUT THE INVENTION

Hereinafter, an embodiment of the present invention will be described with reference to the attached drawings.

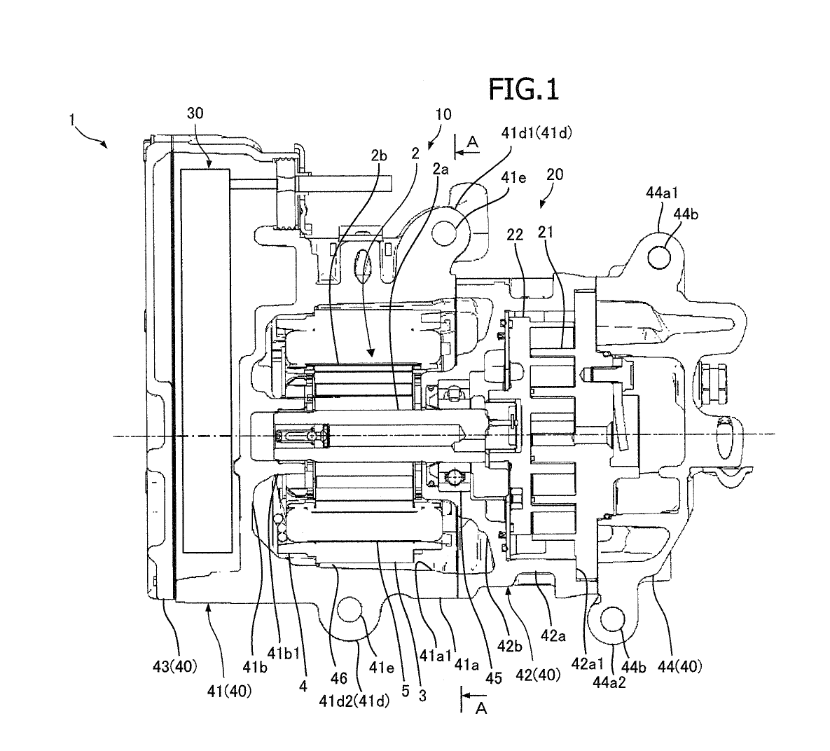

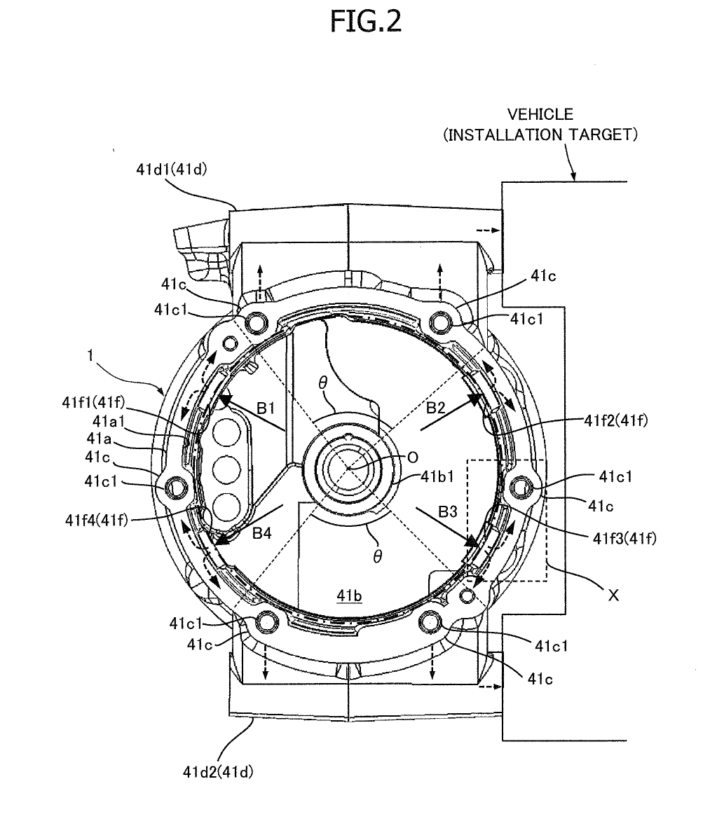

FIG. 1 is a cross-sectional view of an electric compressor according to a first embodiment of the present invention. FIG. 2 is a front view of a first casing 41 as viewed in the direction indicated by arrow A-A of FIG. 1.

An electric compressor 1 according to this embodiment is provided, for example, to a refrigerant circuit for a vehicle air conditioner, and suctions and compresses refrigerant of the vehicle air conditioner and discharges the compressed refrigerant. The electric compressor 1 includes an electric motor 10, a compression mechanism 20 driven by the electric motor 10, an inverter 30 for driving the electric motor 10, and a casing 40 which houses therein the electric motor 10, the compression mechanism 20 and the inverter 30. Note that FIG. 2 does not show the electric motor 10.

In this embodiment, the electric compressor 1 is a so-called inverter-integrated compressor, and has the first casing 41, a second casing 42, an inverter cover 43, and a compression mechanism cover 44. The first casing 41 houses therein the electric motor 10 and the inverter 30, and the second casing 42 houses therein the compression mechanism 20. The casings and covers (41, 42, 43 and 44) are integrally fastened with fastening means (not shown), such as bolts, so as to constitute the casing 40 of the electric compressor 1.

The first casing 41 includes an annular peripheral wall 41a and a partition wall 41b. The partition wall 41b divides the internal space of the first casing 41 into a space for housing the electric motor 10 and a space for housing the inverter 30. The inverter 30 is housed in the first casing 41 through an opening at one end (the left-hand side of FIG. 1) of the peripheral wall 41a, and the opening is closed by the inverter cover 43. The electric motor 10 is housed in the first casing 41 through an opening at the other end (the right-hand side of FIG. 1) of the peripheral wall 41a, and the opening is closed by the second casing 42 (a bottom wall 42b which will be described later). The partition wall 41b includes, at its radially central portion, a tubular support portion 41b1 for supporting one end of a rotating shaft 2a, which will be described later, of the electric motor 10. The tubular support portion 41b1 is provided so as to protrude toward the other end of the peripheral wall 41a.

As shown in FIG. 2, multiple fastening portions 41c (bosses) for fastening the first casing 41 to the second casing 42 are formed on the other end of the first casing 41 so as to be spaced apart from each other in the circumferential direction of the peripheral wall 41a. The fastening portions 41c are thicker than the other portions in this end of the first casing 41. In each fastening portion 41c, a screw hole 41c1 is formed, and a fastening bolt (not shown) is screwed into the screw hole 41c1. Specifically, the six fastening portions 41c are formed equiangularly in the circumferential direction, for example.

In this embodiment, fixing portions 41d for fixing the first casing 41 (the casing 40) to a vehicle which is an installation target are formed protruding from the outer periphery of the peripheral wall 41a of the first casing 41.

Specifically, as shown in FIGS. 1 and 2, the fixing portions 41d of the first casing 41 are an upper fixing portion 41d1 and a lower fixing portion 41d2. In each of the fixing portions 41d1 and 41d2, a through hole 41e is formed so as to extend in, for example, a direction perpendicular to the axis of the rotating shaft 2a, which will be described later, of the electric motor 10. The casing 40 (the electric compressor 1) is fixed to the vehicle by inserting bolts (not shown) through the through holes 41e and screwing the bolts into screw holes formed in the vehicle.

In addition, as shown in FIG. 1, fixing portions 44a (an upper fixing portion 44a1 and a lower fixing portion 44a2) for fixing the casing 40 to the vehicle are formed on the outer periphery of the compression mechanism cover 44 so as to be located at positions respectively corresponding to the fixing portions (41d1 and 41d2) of the first casing 41. In each of these fixing portions (44a1 and 44a2) as well, a through hole 44b for allowing a bolt to be inserted therethrough is formed.

In this embodiment, as shown in FIG. 2, four protrusions 41f are formed protruding from an inner periphery 41a1 of the peripheral wall 41a of the first casing 41 so as to be spaced apart from each other in the circumferential direction. Specifically, the protrusions 41f (41f1, 41f2, 41f3 and 41f4) are formed so as to radially inwardly protrude from the inner periphery 41a1 further than, for example, the fastening portions 41c, and so as to extend throughout the entire length of the first casing 41 in its longitudinal direction.

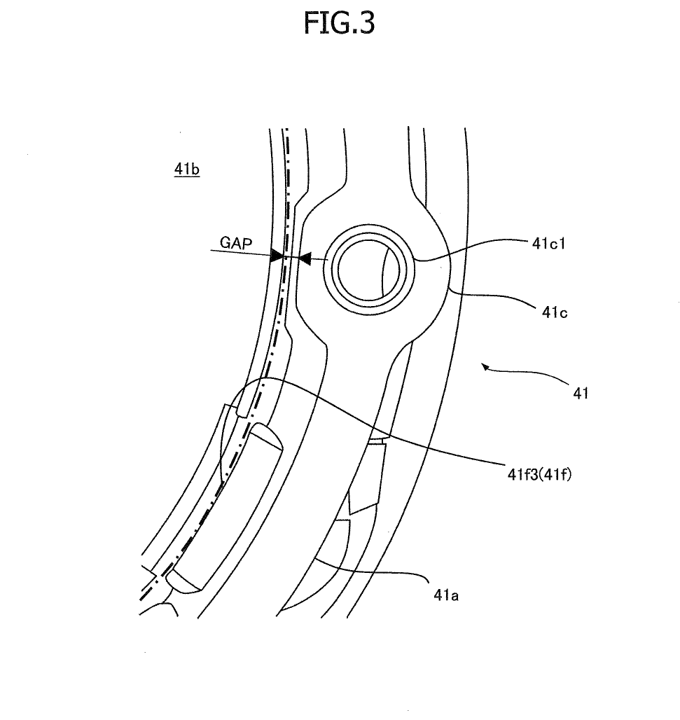

More specifically, as shown in FIG. 3, which is an enlarged view of area X of FIG. 2, the protruding end surface (end surface closer to the rotor 2) of each protrusion 41f is formed in a circular arc shape so as to conform in shape to the outer periphery of a stator 3 (a back yoke 3a, specifically) which will be described later. In addition, there is a gap between an inner diameter circle of the first casing 41 (indicated by dash-dot circle of FIGS. 2 and 3), which extends along these protruding end surfaces, and the inside surfaces of the fastening portions 41c. Note that the protrusions 41f lie outside the cross section shown in FIG. 1 (FIG. 1 does not show a cross section that passes the protrusions 41f).

The stator 3 of the electric motor 10 is fitted to the casing 40 (the first casing 41) by way of the protrusions 41f. For example, the stator 3 is fixed to the casing 40 by shrink fitting the protrusions 41f to the stator 3. With an allowance for shrink fitting taken into account, the first casing 41 is formed so that its inner diameter circle (indicated by dash-dot circle of FIGS. 2 and 3), which extends along the protruding end surfaces of the protrusion 41f, has a diameter smaller than the outside diameter of the stator 3 (the back yoke 3a, specifically).

Specifically, in this embodiment, the protrusions 41f are disposed so that the circumferential angular positions thereof are different from those of the fastening portions 41c, as shown in FIG. 2. More specifically, the protrusions 41f are disposed substantially at the midpoints between the fastening portions 41c.

Still more specifically, in this embodiment, the protrusions 41f are formed to be located within a circumferential angular range that is outside circumferential angular ranges θ occupied by the fixing portions (41d1, 41d2, 44a1 and 44a2), as shown in FIG. 2. As shown in FIG. 2, the angular ranges θ are angles around the rotation axis O of the rotor 2, which will be described later.

The second casing 42 is fastened to the first casing 41 by way of the multiple fastening portions 41c, which are formed on the end of the first casing 41 so as to be spaced apart from each other in the circumferential direction. The second casing 42 is formed in a single open-ended tubular shape having an opening at an end opposite to the end fastened to the first casing 41. The compression mechanism 20 is housed in the second casing 42 through the opening, and this opening of the second casing 42 is closed by the compression mechanism cover 44. The second casing 42 includes a cylindrical portion 42a and the bottom wall 42b formed at one end of the cylindrical portion 42a. The compression mechanism 20 is housed in a space defined by the cylindrical portion 42a and the bottom wall 42b. The bottom wall 42b divides the internal space of the first casing 41 from the internal space of the second casing 42. At the radially central portion of the bottom wall 42b, there is formed a through hole for allowing the other end of the rotating shaft 2a of the electric motor 10 to be inserted therethrough. In addition, a fitting portion for allowing a bearing 45 is to be fitted thereto is formed on the bottom wall 42b. The bearing 45 supports the rotating shaft 2a at its other end.

Moreover, though not shown, in the cylindrical portion 42a of the second casing 42, there are formed multiple through holes for allowing bolts to be inserted therethrough at positions respectively corresponding to the screw holes 41c1 of the first casing 41. These bolts are used for fastening the second casing 42 to the first casing 41. In the cylindrical portion 42a, the portions around the through holes of the cylindrical portion 42a are thicker than the other portions. The first casing 41 is fastened to the second casing 42 by inserting the bolts through the through holes and screwing the bolts into the screw holes 41c1 of the first casing 41.

Furthermore, though not shown, a suction port and a discharge port for the refrigerant are formed in the casing 40. For example, the refrigerant suctioned from the suction port flows through the interior of the first casing 41, and is then suctioned into the second casing 42. Thereby, the suctioned refrigerant cools the electric motor 10. After being compressed by the compression mechanism 20, the refrigerant is discharged from the discharge port.

The electric motor 10 includes the rotor 2, the stator 3, a bobbin 4 and coils 5. The rotor 2 has multiple magnetic poles (not shown). The stator 3 has an annular shape and disposed radially outside the rotor 2. The bobbin 4, which provides electric insulation, is disposed at ends of the stator 3. The coils 5 are wound around the bobbin 4 and the stator 3. For example, the electric motor 10 may be a three-phase alternate-current motor, and the inverter 30 converts a direct current supplied by a vehicle battery (not shown) to an alternating current, and supplies the alternating current to the electric motor 10. The stator 3, the bobbin 4 and the coils 5 constitute a stator unit of the electric motor 10.

In this embodiment, the electric motor 10 is a 6-pole 9-slot three-phase alternate-current motor.

The rotor 2 is formed in a cylindrical shape, and includes multiple permanent magnets embedded at positions spaced apart from each other in the circumferential direction, and rotor cores for holding the permanent magnets, although none of the permanent magnets and rotor cores are not shown. Specifically, north-pole permanent magnets and south-pole permanent magnets are alternately embedded in the rotor 2 at even intervals so as to be spaced apart from each other in the circumferential direction. The rotating shaft 2a is inserted through the rotor 2 so as to rotatably support the rotor 2 at a position radially inside the stator 3. The one end of the rotating shaft 2a is rotatably supported by the support portion 41b1 formed in the first casing 41. The other end of the rotating shaft 2a is inserted through the through hole formed in the second casing 42 and rotatably supported by the bearing 45. The rotating shaft 2a is fitted to a through hole formed at the radial center of the rotor 2 by a method such as shrink fitting, and thereby integrated with the rotor 2. Upon being supplied with a current from the inverter 30, a magnetic field is generated in the stator 3. The magnetic field exerts a torque on the rotor 2, which rotationally drives the rotating shaft 2a. The other end of the rotating shaft 2a is connected with a movable scroll 22, which will be described later, of the compression mechanism 20 so as to drive the movable scroll 22 to orbit therearound.

In this embodiment, three north-pole permanent magnets and three south-pole permanent magnets are embedded in the rotor 2, which thus has six magnetic poles arranged at even intervals.

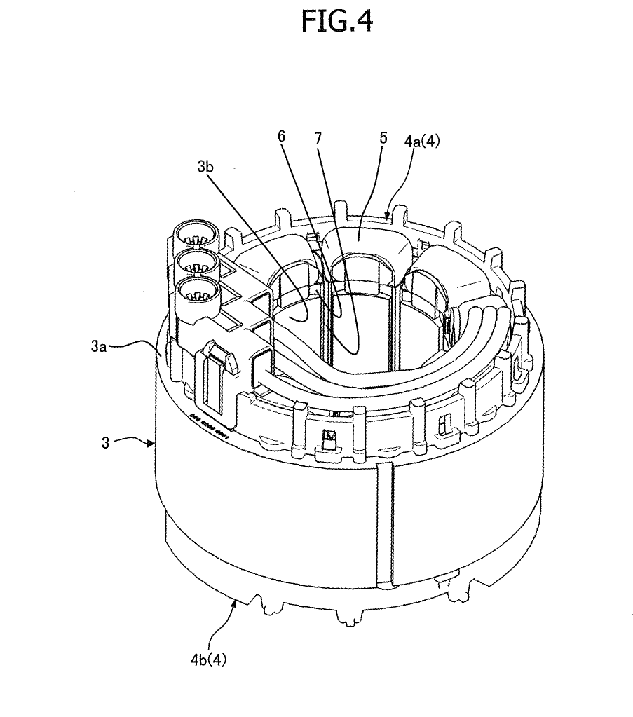

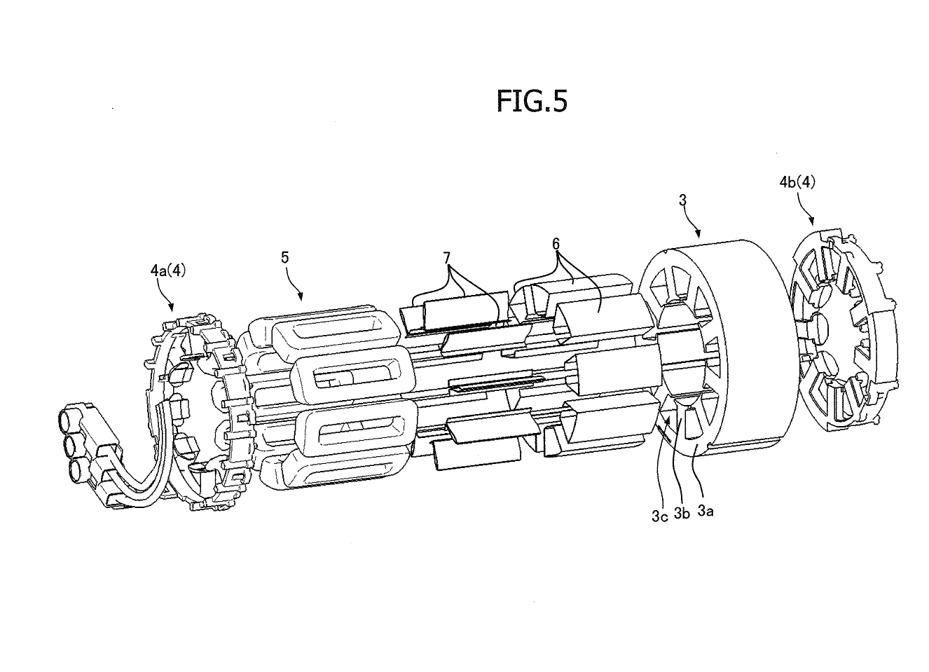

FIG. 4 is a perspective view of the assembled stator unit of the electric motor 10. FIG. 5 is an exploded perspective view of the stator unit.

As shown in FIGS. 4 and 5, the stator 3 has the back yoke 3a and multiple teeth 3b provided so as to radially inwardly protrude from the back yoke 3a, and is formed, for example, of a laminated silicon steel plate. The teeth 3b are formed so as to be spaced apart from each other by a predetermined distance in the circumferential direction of the back yoke 3a. The spaces between the teeth 3b serve as slot portions 3c which open toward the rotor. The back yoke 3a is formed so that its outside diameter is greater than the diameter of the aforementioned inner diameter circle (indicated by dash-dot circle of FIGS. 2 and 3) of the first casing 41.

In this embodiment, the stator 3 has the nine teeth 3b and the nine slots 3c alternately disposed at even intervals.

In each slot portion 3c, inserted is an insulation film 6 which is formed in an appropriate shape (having a substantially C-shaped cross section, for example) so as to conform in shape to the slot portion 3c. The insulation film 6 reliably electrically insulates the stator 3 from the corresponding coil 5. In each slot portion 3c, also inserted is an insulation film 7 which is formed in an appropriate shape having the same longitudinal length as the insulation film 6. The insulation film 7 reliably electrically insulates each adjacent two of the coils 5 from each other. Here, each coil 5 is wound around one of the teeth 3b.

The bobbin 4 is disposed at ends of the stator 3, and may, for example, be disposed respectively at opposite ends, in the axial direction, of the stator 3. The bobbin 4 is formed, for example, of a synthetic resin, and provides electric insulation. The bobbin 4 is vertically separated into two portions, that is, an inverter-side bobbin 4a and a compression-mechanism-side bobbin 4b.

The stator 3, the bobbin 4 and the coils 5 constitute the stator unit shown in FIG. 4. This stator unit is fixed to the first casing 41 by shrink fitting the protrusions 41f to the stator unit. Thereby, the protruding end surfaces of the protrusions 41f come in contact with the outer periphery of the back yoke 3a, while portions between the protrusions 41f of the first casing 41 are spaced apart from the back yoke 3a so as to define air gaps 46 (see FIG. 1).

The compression mechanism 20 is driven by the electric motor 10 to compress the refrigerant, and housed in the second casing 42 so as to be disposed near the other end of the rotating shaft 2a.

In this embodiment, the compression mechanism 20 is a scroll compressor, and includes a fixed scroll 21 and the movable scroll 22. The refrigerant is compressed when the movable scroll 22 is driven to orbit with respect to the fixed scroll 21.

The fixed scroll 21 is fixed to the second casing 42 by bringing an outer periphery portion of the fixed scroll 21 in contact with a step portion formed by providing a recess cut in an end portion of the cylindrical portion 42a.

The movable scroll 22 is disposed between the fixed scroll 21 and the bottom wall 42b, and connected with the other end of the rotating shaft 2a so that the rotation of the rotating shaft 2a can cause the movable scroll 22 to orbit therearound.

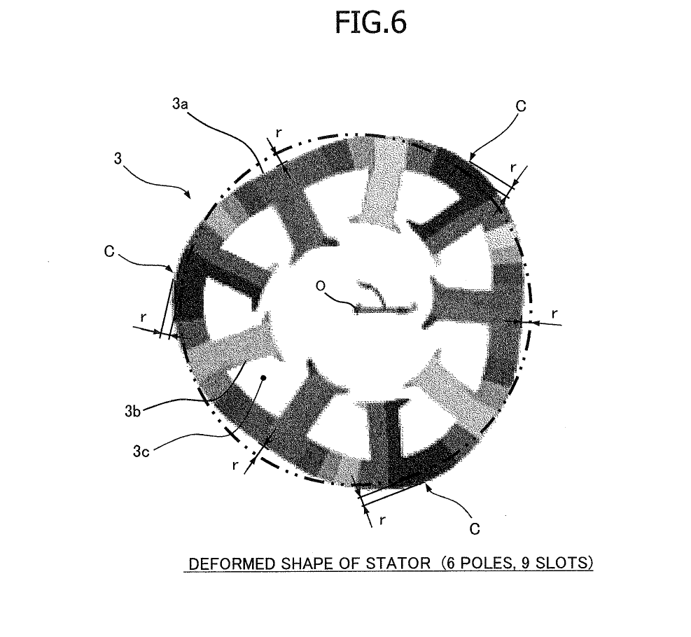

Hereinafter, with reference to FIG. 6, there will be described an analysis result of the shape of the stator 3 that is deformed by an electromagnetic force applied to the stator 3 in the 6-pole (magnetic poles) 9-slot electric motor 10 according to this embodiment. Note that FIG. 6 shows a deformed shape of the stator 3 at a certain moment, and the amount of the deformation of FIG. 6 is greater than it really is (exaggerated) so as to make the deformation more distinctly seen.

As indicated by two-dot chain line of FIG. 6, the stator 3 has a circular outer shape when no electromagnetic force is applied to it. FIG. 6 also shows that the stator 3 is deformed to have a quasi-equilateral triangle outer shape when an electromagnetic force is applied to it. Though not shown, the stator 3 is deformed to have a quasi-equilateral triangle outer shape also at another moment during the electromagnetic force application. However, three corner portions C of the quasi-equilateral triangle move around the rotation axis O of the rotor 2 in synchronization with each other in accordance with the phase and the like of the electric current. The stator 3 vibrates in the radial direction at every point in the circumferential direction as if its deformed shape of quasi-equilateral triangle rotates. A vibration amplitude r of the stator 3 changes in accordance with factors such as the material of stator 3 and the magnitude of the electromagnetic force.

Note that the allowance for shrink fitting between the stator 3 and the first casing 41 is set in view of factors such as this amplitude r and an expected ambient temperature in use so that the stator 3 is appropriately held in the first casing 41 when used. Specifically, the degree of outward displacement of the stator 3 represents the maximum value (amplitude r) at each corner portion C. The protruding length (size in the inner radial direction) of each protrusion 41f is set so that the corner portion C does not come in contact with the inner periphery of the peripheral wall 41a of the first casing 41 while facing any of the air gaps 46 defined between the first casing 41 and the stator 3.

Next, there will be described a vibration transmission suppression effect of the electric compressor 1 according to this embodiment.

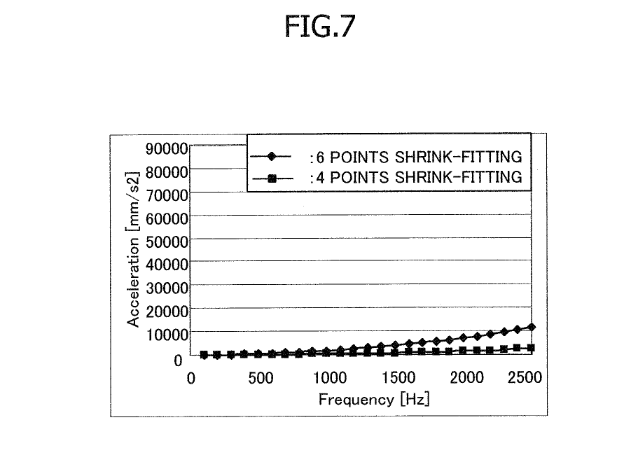

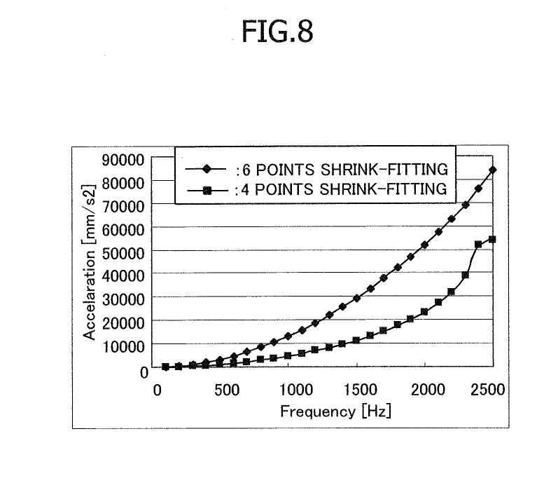

When the inverter 30 supplies an alternating current to the electric motor 10, an electromagnetic force is applied to the stator 3. This deforms the stator 3 to have a quasi-equilateral triangle outer shape as shown in FIG. 6, and causes the stator 3 to vibrate in the radial direction with the amplitude r at every outer peripheral point. Such vibrations are transmitted through the protrusions 41f to the first casing 41 as indicated by dashed arrows of FIG. 2. Here, let vibrations B1, B2, B3 and B4 respectively stand for the vibrations transmitted to the protrusions 41f1, 41f2, 41f3 and 41f4, for example. Each of these vibrations B1, B2, B3 and B4 is transmitted to the first casing 41 through the corresponding one of the protrusions 41f1, 41f2, 41f3 and 41f4 as indicated by dashed arrows, and then transmitted to the upper and lower fixing portions 41d1 and 41d2 after losing its vibration energy by vibrating the thin portions of the peripheral wall portion 41a. As will be described later with reference to FIGS. 7 and 8, the vibration energy generated by the vibration of the stator 3 is sufficiently reduced through this vibration transmission process. Accordingly, when transmitted through the fixing portions 41d1 and 41d2 and reaching the vehicle, the vibration energy is sufficiently reduced.

FIG. 7 shows frequency response characteristics of the upper fixing portion 41d1 while the electric motor 10 vibrates. FIG. 8 shows frequency response characteristics of the lower fixing portion 41d2 while the electric motor 10 vibrates.

In FIGS. 7 and 8, the abscissas represent the frequency of vibration applied to the distal ends of the teeth 3b, and the ordinates represent acceleration rates on the end surfaces of the fixing portions 41d1 and 41d2 when vibration is applied with the frequency, for example. The teeth 3b are vibrated with their vibration phases appropriately shifted from each other. In FIGS. 7 and 8, each solid square indicates a frequency response of a 6-pole 9-slot, four-point shrink-fitted electric compressor (that is, the electric compressor 1 according to this embodiment), and each solid diamond indicates a frequency response of a 6-pole 9-slot, six-point shrink-fitted electric compressor (a compressor that is the same as the electric compressor 1 except for including six protrusions 41f formed at even intervals).

As can be seen in FIGS. 7 and 8, the acceleration rates of the fixing portions 41d1 and 41d2 in the four-point shrink-fitted electric compressor 1 according to this embodiment are less than those in the six-point shrink-fitted electric compressor over the entire frequency domain. This shows that the vibration transmission is reduced in the electric compressor 1 according to this embodiment. In a 6-pole 9-slot electric compressor, the stator 3 is deformed to have a quasi-equilateral triangle outer shape as shown in FIG. 6. Accordingly, if, for example, 3×n protrusions 41f (where n is an integer greater than zero; three protrusions 41f in the case of FIG. 6) are formed at even intervals, all the three corner portions C will simultaneously overlap the positions of the protrusions 41f at a certain moment.

By contrast, in the four-point shrink-fitted electric compressor 1 according to this embodiment, only one of the three corner portions C overlaps any one of the protrusions 41f 1, 41f2, 41f3 and 41f4 at a certain moment. At that moment, the remaining two of the corner portions C face any of the air gaps 46 (see FIG. 1) in contact with nothing but the air, and thus do not vibrate the first casing 41. In other words, the four-point shrink-fitted electric compressor 1 does not cause the situation where two or more of the positions of the corner portions C, which are points of maximum displacement of the stator 3, overlap two or more of the protrusions 41f at a time. This makes it possible to suppress the transmission rate (vibration energy amount transmitted), to the casing 40, of the vibration generated in the stator 3. As a result, the four-point shrink-fitted electric compressor 1 can reduce vibration transmission and can suppress the vibration of the casing 40 as compared, for example, to the six-point shrink-fitted electric compressor shown as an example in FIGS. 7 and 8. Thus, the four-point shrink-fitted electric compressor 1 can also suppress occurrence of radiated sounds due to the vibration of the casing 40.

The electric compressor 1 according to the first embodiment includes the 6-pole 9-slot electric motor 10 in which the stator 3 is fixed to the casing 40 by way of the four protrusions 41f formed protruding from the inner periphery of the casing 40 so as to be spaced apart from each other in the circumferential direction. Thus, the stator 3 may be fixed to the casing 40 by shrink fitting these four protrusions 41f to the stator 3, for example. Therefore, even while an electromagnetic force deforms the stator 3 into a quasi-equilateral triangle and its three corner portions move around the rotation axis O of the rotor 2 in synchronization with each other in accordance with the phase of the electric current, the electric compressor 1 according to the first embodiment permits only one of the three corner portions to overlap any one of the four protrusions at each moment.

This prevents the positions of two or three of the three corner portions from simultaneously overlapping any of the positions of the protrusions 41f at each moment. Thus, the electric compressor 1 according to the first embodiment can more appropriately suppress vibration transmission than an electric compressor that permits such a simultaneous overlap.

In this way, there can be provided an electric compressor capable of appropriately suppressing vibration transmission in consideration of a specific deformed shape of a stator corresponding to the number of its magnetic poles and the number of its slots.

In this embodiment, the fixing portions 41d for fixing the casing 40 to an installation target are formed protruding from the outer periphery of the casing 40, so as to be located within the circumferential angular range that is outside the circumferential angular ranges θ occupied by the fixing portions 41d. Thereby, the protrusions 41f, through which the vibration of the stator 3 is transmitted to the casing 40, can be located away from the fixing portions 41d. Thus, the vibration transmission routes can be made the longest possible so that the vibration energy can be dampened (consumed) through the vibration transmission process. This makes it possible to suppress the vibration transmission to the installation target.

Note that, as described above, the protrusions 41f are formed at locations within the angular range that is outside the angular ranges θ occupied by the fixing portions 41d in this embodiment, but the arrangement of the protrusions 41f is not limited thereto. Alternatively, one or more of the protrusions 41f may be formed at locations within the angular ranges θ. Even in this modification, the 6-pole 9-slot electric motor 10 is fixed to the casing 40 by four-point shrink-fitting, so that the vibration transmission to the installation target can be sufficiently suppressed.

Moreover, though, in this embodiment, the casing 40 has the first casing 41 which houses the electric motor 10, and the second casing 42 which is fastened to the first casing 41 by way of the multiple fastening portions 41c, which are formed on an end of the first casing 41 so as to be spaced apart from each other in the circumferential direction, and the protrusions 41f are disposed so that the angular positions thereof in the circumferential direction are different from those of the fastening portions 41c. Thereby, the protrusions 41f, through which the vibration of the stator 3 is transmitted to the first casing 41, can be disposed not on portions that are tightly fastened with fastening bolts and the like, but on the thin portions of the peripheral wall 41a of the first casing 41. This causes the vibration energy generated in the stator 3 to vibrate the thin portions of the peripheral wall 41a through transmission, so that the thin portions can effectively consume and reduce this vibration energy. This makes it possible to effectively reduce vibration transmission to the vehicle. Moreover, in this embodiment, the protrusions 41f are formed so as to be located substantially at the midpoints between the fastening portions 41c. This allows the thin portions of the peripheral wall 41a to be more effectively vibrated, thus making it possible to more effectively reduce vibration transmission to the vehicle.

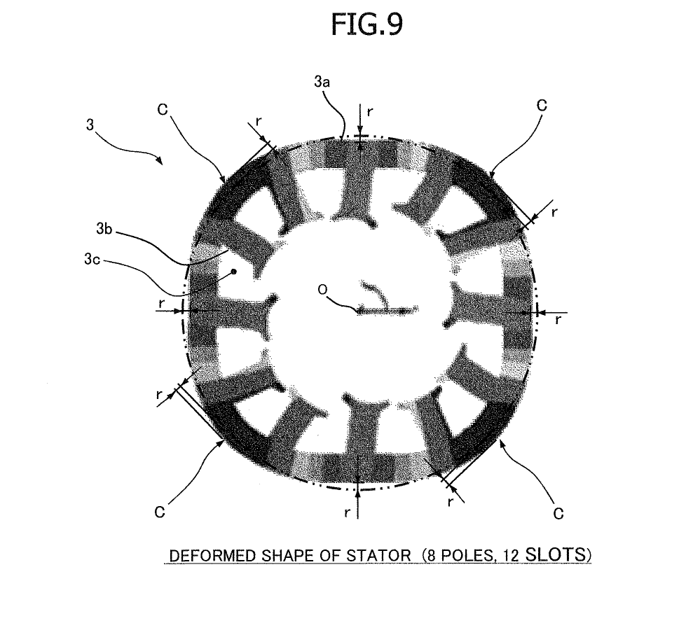

FIG. 9 is a diagram for illustrating a second embodiment of the electric compressor according to the present invention, specifically, a conceptual diagram illustrating a deformed shape of a stator of the electric compressor according to the second embodiment. Note that the same components as those in the first embodiment shown in FIG. 1 are indicated by the same reference numerals and description thereof will be omitted. Hereinafter, only differences from the first embodiment will be described.

The electric motor 10 according to this embodiment, which is a so-called 8-pole 12-slot three-phase alternate-current motor, has eight magnetic poles and twelve slots 3c.

In this embodiment, three protrusions 41f are formed protruding from the inner periphery of the first casing 41 so as to be spaced apart from each other in the circumferential direction. Though not shown, the protrusions 41f are disposed so that the circumferential angular positions thereof are different from those of the fastening portions 41c. Specifically, with reference to FIG. 2, two of the protrusions 41f are disposed at the points where the protrusions 41f 1 and 41f2 are disposed, and the other one is disposed between the two fastening portions 41c that are close to the lower fixing portion 41d2. However, the arrangement of the protrusions 41f is not limited thereto. Alternatively, with reference to FIG. 2, two of the protrusions 41f may be disposed at the points where the protrusions 41f3 and 41f4 are disposed, and the other one may be disposed between the two fastening portions 41c that are close to the upper fixing portion 41d1.

In this embodiment, four north-pole permanent magnets and four south-pole permanent magnets are embedded in the rotor 2, which thus has eight magnetic poles arranged at even intervals.

As shown in FIG. 9, the stator 3 has twelve teeth 3b and twelve slots 3c alternately disposed at even intervals.

Hereinafter, with reference to FIG. 9, there will be described an analysis result of the shape of the stator 3 that is deformed by an electromagnetic force applied to the stator 3 in the 8-pole (magnetic poles) 12-slot electric motor 10 according to this embodiment. Note that FIG. 9 shows a deformed shape of the stator 3 at a certain moment, and the amount of the deformation of FIG. 9 is greater than it really is (exaggerated) so as to make the deformation more distinctly seen.

As indicated by two-dot chain line of FIG. 9, the stator 3 has a circular outer shape when no electromagnetic force is applied to it. FIG. 9 also shows that the stator 3 is deformed to have a quasi-square outer shape when an electromagnetic force is applied to it. Though not shown, the stator 3 is deformed to have a quasi-square outer shape also at another moment during the electromagnetic force application. However, four corner portions C of the quasi-square move around the rotation axis O of the rotor 2 in synchronization with each other in accordance with the phase and the like of the electric current. The stator 3 vibrates at a vibration amplitude r which changes in accordance with factors such as the material of stator 3 and the magnitude of the electromagnetic force.

Next, there will be briefly described a vibration transmission suppression effect of the electric compressor 1 according to this embodiment.

When the inverter 30 supplies an alternating current to the electric motor 10, an electromagnetic force is applied to the stator 3. This deforms the stator 3 to have a quasi-square outer shape as shown in FIG. 9, and causes the stator 3 to vibrate in the radial direction with the amplitude r at every outer peripheral point. Such vibrations are transmitted through the protrusions 41f to the first casing 41, and then transmitted to the upper and lower fixing portions 41d1 and 41d2 after losing its vibration energy by vibrating the thin portions of the peripheral wall 41a. Here, the vibration energy generated by the vibration of the stator 3 is sufficiently reduced through this vibration transmission process. Accordingly, when transmitted through the fixing portions 41d1 and 41d2 and reaching the vehicle, the vibration energy is sufficiently reduced.

In the three-point shrink-fitted electric compressor 1 according to this embodiment, only one of the four corner portions C overlaps any one of the protrusions 41f at a certain moment. At that moment, the remaining three of the corner portions C face any of the air gaps 46 (see FIG. 1) in contact with nothing but the air, and thus do not vibrate the first casing 41. This makes it possible to suppress the transmission rate, to the casing 40, of the vibration generated in the stator 3. As a result, the 8-pole 12-slot three-point shrink-fitted electric compressor 1 can reduce vibration transmission, and can also suppress radiated sounds due to the vibration of the casing 40.

The electric compressor 1 according to this embodiment includes the 8-pole 12-slot electric motor 10 in which the stator 3 is fixed to the casing 40 by way of the three protrusions 41f formed protruding from the inner periphery of the casing 40 so as to be spaced apart from each other in the circumferential direction. Thus, the stator 3 may be fixed to the casing 40 by shrink fitting these three protrusions 41f to the stator 3, for example. Therefore, even while an electromagnetic force deforms the stator 3 into a quasi-square and its four corner portions move around the rotation axis O of the rotor 2 in synchronization with each other in accordance with the phase of the electric current, the electric compressor 1 according to this embodiment permits only one of the four corner portions to overlap any one of the three protrusions at each moment.

This prevents the positions of two to four of the four corner portions from simultaneously overlapping any of the positions of the protrusions 41f at each moment. Thus, the electric compressor 1 according to this embodiment can more appropriately suppress vibration transmission than an electric compressor that permits such a simultaneous overlap.

In this way, there can be provided an electric compressor capable of appropriately suppressing vibration transmission in consideration of a specific deformed shape of a stator corresponding to the number of its magnetic poles and the number of its slots.

Hereinabove, the preferable embodiments of the present invention have been described. However, the present invention is not limited to the embodiments described above, and various changes and modifications may be made based on the technical concept of the present invention.

For example, though the protrusions 41f are disposed so that the circumferential angular positions thereof are different from those of the fastening portions 41c in the above embodiments, the arrangement of the protrusions 41f is not limited thereto. Alternatively, one or more of the protrusions 41f may be disposed so that the angular positions thereof are the same as any of those of the fastening portions 41c. Even in this modification, the 6-pole 9-slot electric motor 10 is fixed to the casing 40 by four-point shrink-fitting, or the 8-pole 12-slot electric motor 10 is fixed to the casing 40 by three-point shrink-fitting, so that the vibration transmission to the installation target can be sufficiently suppressed.

Though the protrusions 41f are formed on the inner periphery of the casing 40 (the first casing 41) in the above embodiments, the present invention is not limited thereto. Alternatively, though not shown, the protrusions 41f may be formed on the outer periphery of the stator 3.

Moreover, though the stator 3 is fixed to the casing 40 by shrink fitting the protrusions 41f to the stator 3 in the above embodiments. However, the fixing method is not limited to this. Alternatively, the stator 3 may be fixed by an appropriate method such as cool fitting, press fitting or swaging. It is only necessary to fix the stator 3 to the casing by way of the protrusions 41f. Furthermore, the number of the fastening portions 41c is six in the above embodiments, but not limited to this. An appropriate number of the fastening portions 41c may be formed.

Though a scroll compressor is used as the compression mechanism 20 in the electric compressor 1, the present invention is not limited to this. Instead, an appropriate type electric compressor such as a swash-plate compressor may be used as the compression mechanism 20.

### REFERENCE SYMBOL LIST

1 Electric compressor
2 Rotor
3 Stator
3c Slot
10 Electric motor
20 Compression mechanism
40 Casing
41 First casing
41c fastening portion
41d Fixing portion
41f Protrusion
42 Second casing
44a Fixing portion

1. An electric compressor including: an electric motor which includes a rotor that has six magnetic poles, and a stator that is disposed radially outside the rotor and that has nine slots opening toward the rotor; a compression mechanism driven by the electric motor to compress refrigerant; and a casing which houses the electric motor and the compression mechanism, the electric compressor comprising four protrusions formed protruding from either an inner periphery of the casing or an outer periphery of the stator so as to be spaced apart from each other in a circumferential direction, wherein the stator is fixed to the casing by way of the protrusions.

2. An electric compressor including: an electric motor which includes a rotor that has eight magnetic poles, and a stator that is disposed radially outside the rotor and that has twelve slots opening toward the rotor; a compression mechanism driven by the electric motor to compress refrigerant; and a casing which houses the electric motor and the compression mechanism, the electric compressor comprising three protrusions formed protruding from either an inner periphery of the casing or an outer periphery of the stator so as to be spaced apart from each other in a circumferential direction, wherein the stator is fixed to the casing by way of the protrusions.

3. The electric compressor according to claim 1, further comprising a fixing portion for fixing the casing to an installation target, the fixing portion being formed protruding from an outer periphery of the casing, wherein the protrusions are formed to be located within a circumferential angular range that is outside a circumferential angular range occupied by the fixing portion.

4. The electric compressor according to claim 3, wherein
the casing has at least a first casing for housing the electric motor, and a second casing fastened to the first casing by way of a plurality of fastening portions formed on an end of the first casing so as to be spaced apart from each other in the circumferential direction, and
the protrusions are disposed so that circumferential angular positions thereof are different from circumferential angular positions of the fastening portions.

5. The electric compressor according to claim 1, wherein
the casing has at least a first casing for housing the electric motor, and a second casing fastened to the first casing by way of a plurality of fastening portions formed on an end of the first casing so as to be spaced apart from each other in the circumferential direction, and
the protrusions are disposed so that circumferential angular positions thereof are different from circumferential angular positions of the fastening portions.

6. The electric compressor according to claim 2, wherein
the casing has at least a first casing for housing the electric motor, and a second casing fastened to the first casing by way of a plurality of fastening portions formed on an end of the first casing so as to be spaced apart from each other in the circumferential direction, and
the protrusions are disposed so that circumferential angular positions thereof are different from circumferential angular positions of the fastening portions.
